(19) United States
(12) Patent Application Publication
(10) Pub. No.: US 2026/0018987 A1
(43) Pub. Date: Jan. 15, 2026

(54) POWER CONVERTER CONTROL DEVICE

(71) Applicant: NAGASAKI INSTITUTE OF APPLIED SCIENCE, Nagasaki (JP)

(72) Inventor: Fujio KUROKAWA, Nagasaki (JP)

(21) Appl. No.: 19/337,992

(22) Filed: Sep. 24, 2025

Related U.S. Application Data
(63) Continuation of application No. PCT/JP2024/010760, filed on Mar. 19, 2024.

(30) Foreign Application Priority Data
Mar. 27, 2023 (JP) 2023-049775

(51) Int. Cl. H02M 1/00

(52) U.S. Cl. CPC H02M 1/0074; H02M 1/0025

(57) ABSTRACT

Provided is a power converter control device that includes a plurality of power converters, and a control unit configured to feedback-control the power converters and configured to correct ON-time of the plurality of power converters in accordance with reference voltage based on input voltage of each of the plurality of power converters.

### CROSS-REFERENCE TO RELATED APPLICATIONS

This application is a Continuation Application of PCT International Application No. PCT/JP2024/010760, filed on Mar. 19, 2024, which is based upon and claims the benefit of priority from Japanese Patent Application No. 2023-049775, filed on Mar. 27, 2023, the disclosure of which is hereby incorporated by reference herein in their entireties.

### TECHNICAL FIELD

The present invention relates to a power converter control device that controls a plurality of power converters (converters).

### BACKGROUND ART

Hitherto, when a plurality of connected power converters are controlled, each power converter has been provided with a feedback control circuit, and an individualized feedback control has been performed for each power converter by the feedback control circuit.

Here, as a related-art literature in which a system that controls a plurality of connected power converters is described, Non Patent Literature 1 exists.

In Non Patent Literature 1, high input voltage auxiliary power supplies aimed to reduce cost are described. An approach employed by the high-input-voltage auxiliary power supplies is based on converters that are connected by an input series output parallel connection, and maintains the balance between the connected converters by controlling main output voltage by a master converter and controlling input voltage and output current by a slave converter.

A form in which a control unit is not provided is also known. For example, FIG. 7 is a diagram showing the configuration of two-series-input two-series-output converters without a control unit.

In the configuration shown in FIG. 7, two power converters are connected in series on the input side and are also connected in a series-parallel configuration on the output side.

Each power converter includes a corresponding one of first power MOSFETS Q₁₁, S₂₁ and a corresponding one of second power MOSFETS Q₁₂, Q₂₂. First gate voltage signals S_{gs11}, S_{gs21} are input to the first power MOSFETS Q₁₁, S₂₁, and second gate voltage signals S_{ga21}, S_{gs22} are input to the second powers MOSFETS Q₁₂, Q₂₂.

Problems do not occur when, with respect to the first gate voltage signal S_{gs11} input to the first power MOSFETQ11 of one power converter, the first gate voltage signal S_{gs21} input to the first power MOSFETQ₂₁ of the other power converter is not delayed. However, when a delay occurs, a state as shown in FIGS. 8(A) and 8(B) is obtained.

Here, Vᵢₙ=1500 V is satisfied, and FIGS. 8(A) and 8(B) show input voltage Vᵢₙ₁, input current Vᵢₙ₁, input-side transformer voltage Vₜᵣ₁ of one power converter, and input voltage Vᵢₙ₂, input current Vᵢₙ₂, and input-side transformer voltage Vₜᵣ₂ of the other power converter.

As shown in FIG. 8(A), when turn-OFF-time of S_{gs21} is delayed from S_{gs11} by 0.1 μsa, it can be understood that the balance between the input voltages is becoming disrupted due to the difference in the ON-time with Vᵢₙ₁=768 V and Vᵢₙ₂=733 V being satisfied. As shown in FIG. 8(B), when turn-OFF-time of S_{qs21} is delayed from S_{gs11} by 1 μs, it can be understood that the balance between the input voltages is disrupted by a large degree with Vᵢₙ₁=906 V and Vᵢₙ₂=594 V being satisfied. As above, the balance between the input voltages worsens in proportion to the increase of the difference in the ON-time of the gate signals.

### CITATION LIST

### Non Patent Literature

Non Patent Literature 1: Petar J. Grbovic, Master/Slave Control of Input-Series-and Output-Parallel-Connected Converters: Concept for Low-Cost High-Voltage Auxiliary Power Supplies, IEEE TRANSACTIONS ON POWER ELECTRONICS, VOL. 24, NO. 2, February 2009, pp. 316-327, 2009.

### SUMMARY OF INVENTION

### Technical Problem

As above, when a feedback control circuit is not provided, the balance between the input voltages easily worsens. When control is performed by the master converter and the slave converter as in an approach described in Non Patent Literature 1, for example, current on the input side is used at the time of the control. Therefore, there has been a problem in that the control becomes complicated and that it is difficult to detect the current on the input side.

Therefore, an object of the present invention is to provide a power converter control device capable of controlling the balance between input voltages of a plurality of power converters connected in series by controlling the plurality of power converters with a simpler structure.

### Solution to Problem

A power converter control device of the present invention includes a plurality of power converters, and a control unit configured to feedback-control each of the power converters and configured to correct ON-time of the plurality of power converters in accordance with reference voltage based on input voltage of each of the plurality of power converters.

In the power converter control device, when the number of the control units is one, the control unit is preferably configured to correct the ON-time of the plurality of power converters such that input voltage is same for all of the plurality of power converters.

In the power converter control device, when the number of the control units is two or more and is less than the plurality of power converters, the two or more control units are preferably configured to correct the ON-time of the plurality of power converters with use of an average value of the ON-time when the two or more control units individually correct the power converters, respectively.

When the control unit corrects the ON-time of the plurality of power converters, the control unit is preferably configured to correct the ON-time by comparing input voltage of one of the power converters that serves as a reference and input voltage of another one of the power converters out of the power converters one by one, or correct the ON-time by repeating parallel processing and comparison of the input voltage of the power converter that serves as the reference and the input voltage of the other power converter out of the power converters at once.

Alternatively, the control unit is preferably configured to determine a difference between the input voltage of the power converter that serves as the reference and the input voltage of the other power converter out of the power converters with use of a comparator and correct an ON-width and an OFF-width of the input voltage of the other power converter with use of a counter based on the difference.

### Advantageous Effects of Invention

The power converter control device of the present invention is capable of controlling the balance between the input voltages of the plurality of power converters connected in series with a simple structure by calculating the reference voltage based on the input voltage of each converter that is easily detected and correcting the ON-time in accordance with the reference voltage by the configuration of including the plurality of power converters, and the control unit configured to feedback-control each of the power converters and configured to correct the ON-time of the plurality of power converters in accordance with the reference voltage based on the input voltage of the plurality of power converters,.

### BRIEF DESCRIPTION OF DRAWINGS

FIG. 1 is a diagram for describing the configuration of a power converter control device according to an embodiment of the present invention.

FIG. 2 is a diagram for describing the configuration of a power converter control device according to another embodiment of the present invention.

FIG. 3 is a diagram for describing the configuration of a control unit according to the embodiment of the present invention.

FIG. 4 is a diagram for describing the configuration of the control unit according to the embodiment of the present invention.

FIG. 5 is a diagram for describing a control system of the control unit.

FIG. 6 is a diagram showing a simulation result of the power converter control device according to the embodiment of the present invention.

FIG. 7 is a diagram showing the configuration of a two-series-input two-series-output converter of the related art without a control unit.

FIG. 8(A) and FIG. 8(B) are diagrams showing one example of a case in which the input voltage balance is lost.

### DESCRIPTION OF EMBODIMENTS

Embodiments of the present invention are described in detail below, but the description of the configuration described below is one example (representative example) of embodiments of the present invention, and the present invention is not limited to the content below as long as the gist thereof is not changed.

### Power Converter Control Device

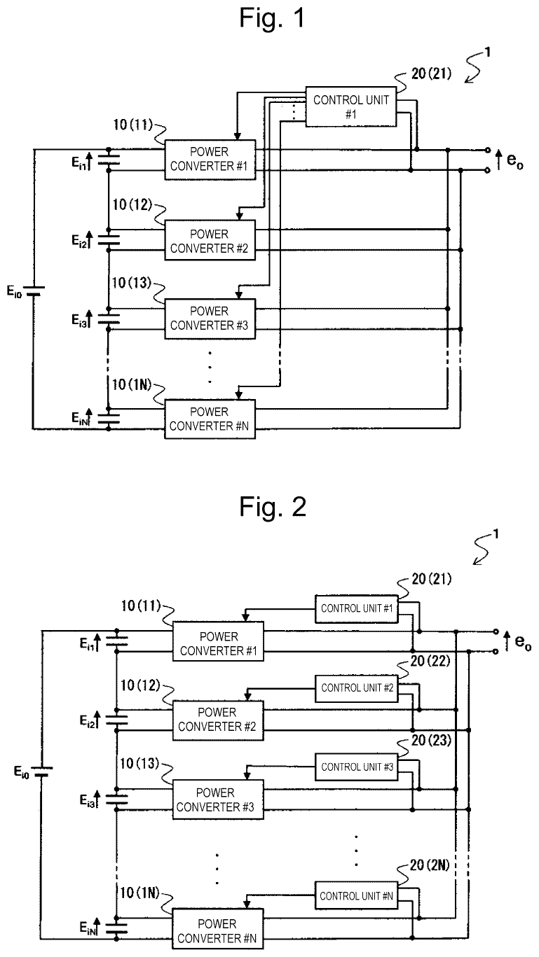

FIG. 1 is a diagram for describing the configuration of a power converter control device according to an embodiment of the present invention.

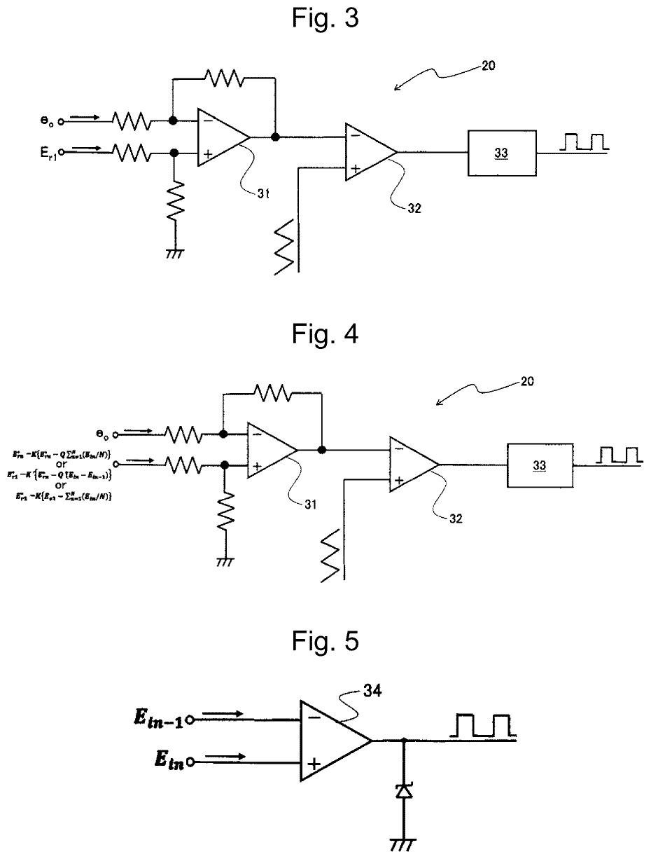

As shown in FIG. 1, the power converter control device 1 is configured by a plurality of power converters 10 of which input sides are connected in series, and a control unit 20 that feedback-controls the power converters 10. The control unit 20 corrects ON-time of the plurality of power converters 10 by reference voltage based on input voltages of the plurality of power converters 10. In particular, the control unit 20 performs control shown in FIGS. 3 to 5, and the control is described later.

The power converter 10 is a so-called converter, and includes a DC-DC converter, a DC-AC converter, an AC-DC converter, an AC-AC converter, feedforward control that also detects input voltage, or the like. Other than the above, the power converter 10 can also be applied to a bi-directional power converter (for example, a DAB converter (isolated bi-directional power converter). In other words, the plurality of power converters 10 may be connected to each other in series or in parallel on the input side, and may be connected to each other in series or in parallel on the output side as well.

Hitherto, when the plurality of connected power converters 10 are to be controlled, a feedback control circuit has been provided in each of the power converters 10 (11 to 1N). In each of the power converters 10 (11 to 1N), a more individualized feedback control has been performed by each feedback control circuit.

Meanwhile, in the power converter control device 1 of the present invention, the number of control units that serve as the feedback control circuits is set to be a freely-selected number equal to or less than the number of installations of the power converters 10.

In the embodiment shown in FIG. 1, the power converter control device 1 has a configuration with only one control unit 20 (21).

FIG. 2 is a diagram for describing the configuration of a power converter control device according to another embodiment of the present invention. In the embodiment shown in FIG. 2, the power converter control device 1 has a configuration in which the power converters 10 (11 to 1N) are respectively provided with the control units 20 (21 to 2N), but the number of the control units 20 can be freely-selected.

In the power converter control device of the case shown in FIGS. 1 and 2, the input voltage of each of the power converters 10 is detected in the control unit 20 (information on input voltage of each of the power converters 10 is transmitted to the control unit 20).

### Control Unit

FIG. 3 is a diagram for describing the configuration of the control unit (control circuit) according to the embodiment of the present invention.

As shown in FIG. 3, the control unit 20 has a differential amplifier 31, a compensation circuit 32, and a PWM generation circuit 33. The control unit 20 performs control of correcting the ON-time of the power converter 10 by reference voltage Eᵣ₁ based on the input voltage of each of the power converters 10. In other words, by performing control based on the reference voltage Eᵣ₁ of each of the power converters 10, the balance between each input voltage of each of the power converters 10 is maintained. The timing adjustment is performed by inputting a timing signal in accordance with a sawtooth wave to a non-inverting input terminal of the compensation circuit 32. The timing signal is generated with a generator (not shown).

The reference voltage Eᵣ₁ based on the input voltage of the power converter 10 (11) is obtained by Expression (1) below. Expression (2) below is an expression that obtains reference voltage Ern of an N-th power converter 10, and Expression (3) below is a general expression thereof. In the expressions, E*ᵣ₁, E*_{rN}, and E*ᵣₙ are fixed values set in advance along with the start of operation of the power converter control device and is a voltage value that can fluctuate by adjustment from the outside.

$$\begin{matrix}[ Math 1 ] & \\ {E}_{r 1}^{*} - K \{ {E}_{r 1}^{*} - Q {\sum }_{n = 1}^{N} ( {E}_{in} / N ) \} & ( 1 )\end{matrix}$$

$$\begin{matrix}[ Math 2 ] & \\ {E}_{rN}^{*} - K \{ {E}_{rN}^{*} - Q {\sum }_{n = 1}^{N} ( {E}_{in} / N ) \} & ( 2 )\end{matrix}$$

$$\begin{matrix}[ Math 3 ] & \\ {E}_{rn}^{*} - K \{ {E}_{rn}^{*} - Q {\sum }_{n = 1}^{N} ( {E}_{in} / N ) \} & ( 3 )\end{matrix}$$

As above, the control unit 20 (21) calculates the reference voltage Eᵣᵢ, and performs control of correcting the ON-time of the power converter 10 by the reference voltage Eᵣ₁.

In Expressions (1), (2), and (3) above, Q represents a coefficient based on the number of the control units, and K represents a coefficient that defines how small the difference between Eᵣ₁ and an average value of all of Eᵢ is to be set in Expression (1) and is similar in the other expressions. When Q=1 is satisfied, Expression (1) above is as follows.

$$\begin{matrix}[ Math 4 ] & \\ {E}_{r 1}^{*} - K \{ {E}_{i 1} - {\sum }_{n = 1}^{N} ( {E}_{in} / N ) \} & ( {1}^{′} )\end{matrix}$$

As shown in FIG. 2, in the power converter control device including the plurality of power converters 10 (11 to 1N), when the individual power converters 10 (11 to 1N) are respectively provided with the control units 20 (21 to 2N), reference voltage Eᵣₙ of an n-th other power converter In is controlled by voltage calculated by Expression (3) above or Expression (4) below as shown in FIG. 4. When the number of the control units 20 is one where Q=1, control is performed by voltage calculated by Expression (1′) above.

In particular, the balance between each input voltage can be maintained by repeating comparison every two to M input voltages such as comparison between Eᵢ₁ and Eᵢ₂, comparison between Eᵢ₂ and Eᵢ₃, . . . , and comparison between Eᵢₙ₋₁ and E_{iN} with use of Expression (4) below.

In Expression (4) below, K′ is the same coefficient as K described above, and Q′ is also the same coefficient as Q described above as well.

$$\begin{matrix}[ Math 5 ] & \\ {E}_{r 1}^{*} - {K}^{′} \{ {E}_{rn}^{*} - {Q}^{′} ( {E}_{in} - {E}_{in - 1} \} & ( 4 )\end{matrix}$$

In other words, as shown in FIG. 3, only one power converter 10 (11) is provided with the control unit 20 (21), and the other power converters 10 (12 to 1N) can also be controlled by considering that the input voltages thereof are the same as that of the power converter 10 (11).

Alternatively, as shown in FIG. 4, the other power converters 10 (12 to 1N) can be controlled by the reference voltage based on Expressions (3), (4), and (1′).

The control unit 20 shown in FIG. 4 has the differential amplifier 31, the compensation circuit 32, and the PWM generation circuit 33. The reference voltage based on Expressions (3), (4), and (1′) above is input to a non-inverting input terminal of the differential amplifier 31, and a control signal that controls the power converters 10 (11 to 1N) is generated. The timing adjustment is performed by inputting a timing signal in accordance with a sawtooth wave to the non-inverting input terminal of the compensation circuit 32 in this case as well. The timing signal is generated with a generator (not shown).

When the number of the control units 20 is two or more and is equal to or less than the number of the power converters 10 (11 to 1N), the control units 20 (21, 22, 23, 2N) correct the ON-time of the plurality of power converters 10 (11 to 1N) with use of an average value of the ON-time when the control units 20 (21, 22, 23, 2N) individually correct the power converters 10 (11, 12, 13, 1N), respectively. In other words, the control unit 20 provided for each of the power converters 10 performs the feedback control and controls the reference voltage of each of the power converters 10.

In this case, in the power converter 10 that is not provided with the control unit 20, a control signal generated by the control unit 20 provided for the adjacent power converter 10 is used.

Alternatively, as shown in FIG. 5, the control signal may be adjusted by operating the comparator 34 with use of a difference between the input voltage Ein of the power converter 10 and input voltage Eᵢₙ₋₁ of the adjacent power converter 10.

In the comparator 34, when Eᵢₙ>Eᵢₙ₋₁ is satisfied, signal adjustment of reducing ON-time of Eᵢₙ by a predetermined amount of time and increasing OFF-time of Eᵢₙ by the predetermined amount of time as a result is performed. When Eᵢₙ<Eᵢₙ₋₁ is satisfied, signal adjustment of increasing the ON-time of Eᵢₙ by a predetermined amount of time and reducing the OFF-time of Eᵢₙ by the predetermined amount of time as a result is performed.

In the embodiment described above, a case in which the control unit 20 is configured with use of the differential amplifier 31, the compensation circuit 32, or electronic elements such as the comparator 34 has been described. However, the control unit 20 may be configured as control signal generating means for generating a control signal by executing an appropriate program.

As above, the power converter control device 1 can control the balance between the input voltages of the plurality of power converters connected in series by controlling the plurality of power converters.

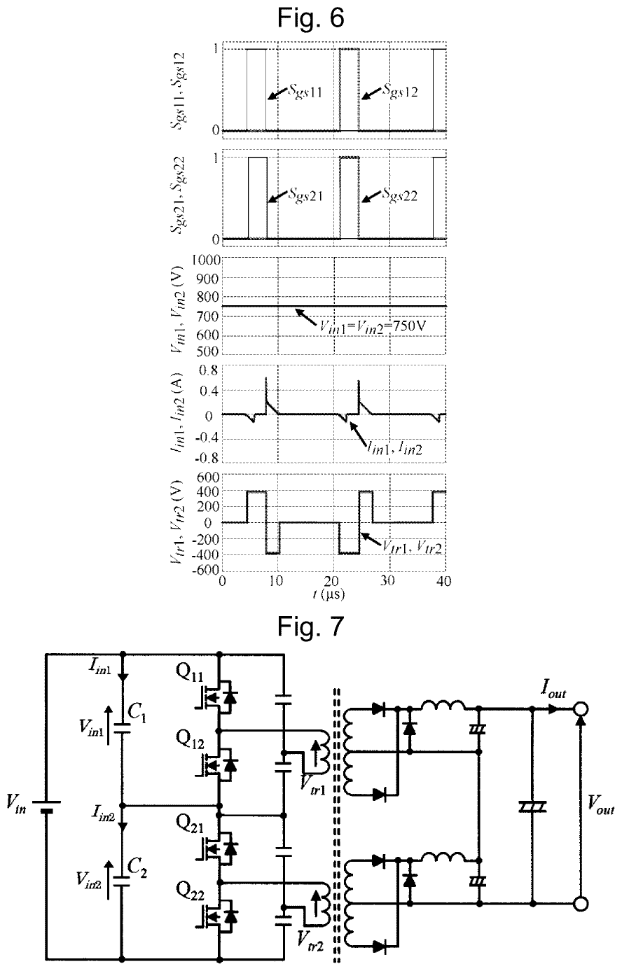

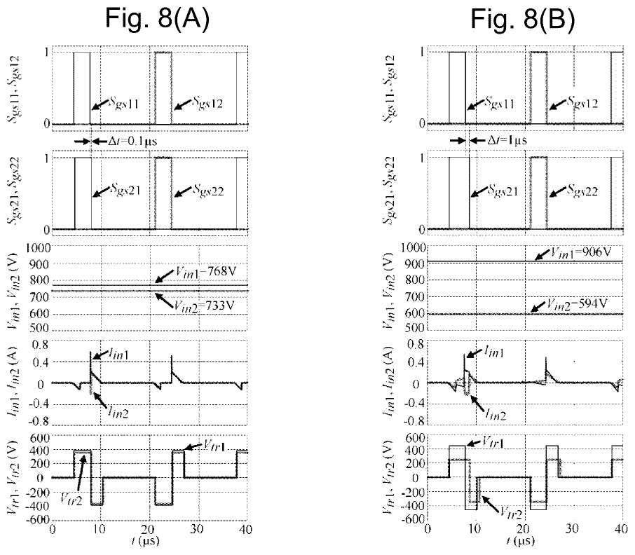

For example, FIG. 6 is a diagram showing a simulation result of a case in which the power converter control device according to the embodiment of the present invention is applied to the two-series-input two-series-output converter described above. According to the power converter control device of the present invention, as shown in FIG. 6, Vᵢₙ₁ and Vᵢₙ₂ are both 750 V, and the balance between the input voltages has been able to be controlled.

As described above, the power converter control device of the present invention can control the balance between the input voltages with only the detection of the voltages on the input side. Therefore, it becomes easier to realize the balance control than balance control using current on the input side that is difficult to detect.

The power converter control device 1 described as above is an exemplification of the power converter control device of the present invention, and the configuration of the present invention is not limited to the exemplification as long as the configuration does not depart from the gist of the present invention.

For example, a control system as follows can be employed. In the control system, when the control unit 20 corrects the ON-time of the plurality of power converters 10 (11 to 1N), the control unit 20 corrects the ON-time by comparing the input voltage of the power converter (for example, the power converter 11) that serves as a reference and the input voltages of the other power converters (for example, the power converters 12 to 1N) out of the power converters 10 one by one.

Alternatively, a control system as follows can be employed. In the control system, the control unit 20 corrects the ON-time by repeating parallel processing and comparison of the input voltage of the power converter (for example, the power converter 11) that serves as a reference and the input voltages of the other power converters (for example, the power converters 12 to 1N) out of the power converters 10 at once.

### Industrial Applicability

The power converter control device according to the present invention can control the balance between input voltages of a plurality of power converters connected in series by controlling the plurality of power converters with a simple structure and can be used in various scenes. Therefore, the power converter control device is industrially useful.

### Reference Signs List

1 power converter control device
10, 11, 12, 13, 1N power converter
20, 21, 22, 23, 2N control unit
31 differential amplifier
32 compensation circuit
33 PWM generation circuit
34 comparator

1. A power converter control device, comprising:
a plurality of power converters; and
a control unit configured to feedback-control each of the power converters and configured to correct ON-time of the plurality of power converters in accordance with reference voltage based on input voltage of each of the plurality of power converters.

2. The power converter control device according to claim 1, wherein, when a number of the control units is one, the control unit is configured to correct the ON-time of the plurality of power converters such that input voltage is same for all of the plurality of power converters.

3. The power converter control device according to claim 1, wherein, when a number of the control units is two or more and is less than the plurality of power converters, the two or more control units are configured to correct the ON-time of the plurality of power converters with use of an average value of the ON-time when the two or more control units individually correct the power converters, respectively.

4. The power converter control device according to claim 2, wherein, when the control unit corrects the ON-time of the plurality of power converters, the control unit is configured to:
correct the ON-time by comparing input voltage of one of the power converters that serves as a reference and input voltage of another one of the power converters out of the power converters one by one; or
correct the ON-time by repeating parallel processing and comparison of the input voltage of the power converter that serves as the reference and the input voltage of the other power converter out of the power converters at once.

5. The power converter control device according to claim 4, wherein the control unit is configured to determine a difference between the input voltage of the power converter that serves as the reference and the input voltage of the other power converter out of the power converters with use of a comparator and correct an ON-width and an OFF-width of the input voltage of the other power converter with use of a counter based on the difference.
